(19) United States
(12) Patent Application Publication
(10) Pub. No.: US 2008/0239613 A1
(43) Pub. Date: Oct. 2, 2008

(54) ACTIVE MATRIX DEVICE OR A FLAT PANEL DISPLAY WITH ELECTROSTATIC PROTECTION

(75) Inventors: Chuan-Feng Liu, Hsinchu (TW); Chi-Ming Wu, Hsinchu (TW)

Correspondence Address: SHEEHAN PHINNEY BASS & GREEN, PA;c/o PETER NIEVES, 1000 ELM STREET, MANCHESTER, NH, 03105-3701, US

(73) Assignee: Prime View International Co., Ltd., Hsinchu (TW)

(21) Appl. No.: 11/767,593

(22) Filed: Jun. 25, 2007

(30) Foreign Application Priority Data
Mar. 27, 2007 (TW) 96110587

(51) Int. Cl. H05F 3/00

(52) U.S. Cl. 361/220

(57) ABSTRACT

An active matrix device or a flat panel display, includes a substrate, a scan line and a data line, a pixel, an electrostatic discharge ring, a first diode, a second diode, a third diode and a forth diode. The anodes of the first diode and the fourth diode are coupled to the scan line, and the cathodes of the first diode and the fourth diode are coupled to the electrostatic discharge ring. The anodes of the second diode and the third diode are coupled to the electrostatic discharge ring, and the cathodes of the second diode and the third diode are coupled to the scan line.

### RELATED APPLICATIONS

This application claims priority to Taiwan Application Serial Number 96110587, filed Mar. 27, 2007, which is herein incorporated by reference.

### BACKGROUND

1. Field of Invention

The present invention relates to an active matrix device. More particularly, the present invention relates to an active matrix device with electrostatic protection.

2. Description of Related Art

Generally speaking, electrostatic voltage in the environment or in human beings may be as high as several thousand volts. If an electrostatic current with such a high voltage in an operator enters the active matrix device during the manufacturing process of the active matrix device (such as Liquid Crystal Display, OLED display, and ElectroPhoretic Display), the electronic devices of the active matrix device, such as Thin Field Transistor, might be destroyed.

To prevent the electronic devices from being damaged by the electrostatic current, an Electrostatic Discharge Ring (ESD Ring) is disposed on the substrate of the active matrix device. The data line or the scan line is coupled to the ESD Ring through a pair of diodes. If there is electrostatic current on the scan lines, the data lines or the substrate, the electrostatic current is discharged to the ESD Ring through the pair of diodes and consumed by the ESD Ring, which prevents the electronic devices of the active matrix device from being damaged.

However, in such an active matrix device, if one of the two diodes is destroyed, the positive or negative electrostatic current cannot be delivered to the ESD ring and the electrostatic energy is therefore not consumed. In addition, if the volume of the electrostatic current is too large, only two diodes cannot deliver the electrostatic current to the ESD ring effectively. The remaining electrostatic current on the substrate, the data line or the scan line might therefore still destroy the electronic devices of the active matrix device.

For the foregoing reasons, there is a need for a new active matrix device that can deliver the electrostatic current to the ESD ring more effectively to prevent the electronic devices of the active matrix device from being damaged.

### SUMMARY

According to one embodiment of the present invention, an active matrix device includes a substrate, a scan line, a data line, a pixel, at least one electrostatic discharge ring, a first diode, a fourth diode, a second diode, and a third diode. The scan line is disposed on the substrate. The data line, disposed on the substrate, is across the scan line. The pixel is electrically coupled to the data line and the scan line.

The electrostatic discharge ring, disposed on the substrate across the data line and the scan line, consumes electrostatic energy. The first diode and a fourth diode have anodes coupled to the scan line and cathodes coupled to the electrostatic discharge ring. The second diode and the third diode have anodes coupled to the electrostatic discharge ring and cathodes coupled to the scan line.

According to another embodiment of the present invention, a flat panel display includes a substrate, a scan line, a data line, at least one thin film transistor, at least one electrostatic discharge ring, a first diode, a fourth diode, a second diode and a third diode. The scan line is disposed on the substrate. The data line is disposed on the substrate across the scan line. The thin film transistor disposed on the substrate has a gate coupled to the scan line and a first source/drain coupled to the data line.

The electrostatic discharge ring, disposed on the substrate across the data line and the scan line, consumes electrostatic energy. The first diode and a fourth diode have anodes coupled to the scan line and cathodes coupled to the electrostatic discharge ring. The second diode and the third diode have anodes coupled to the electrostatic discharge ring and cathodes coupled to the scan line.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is an active matrix device according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

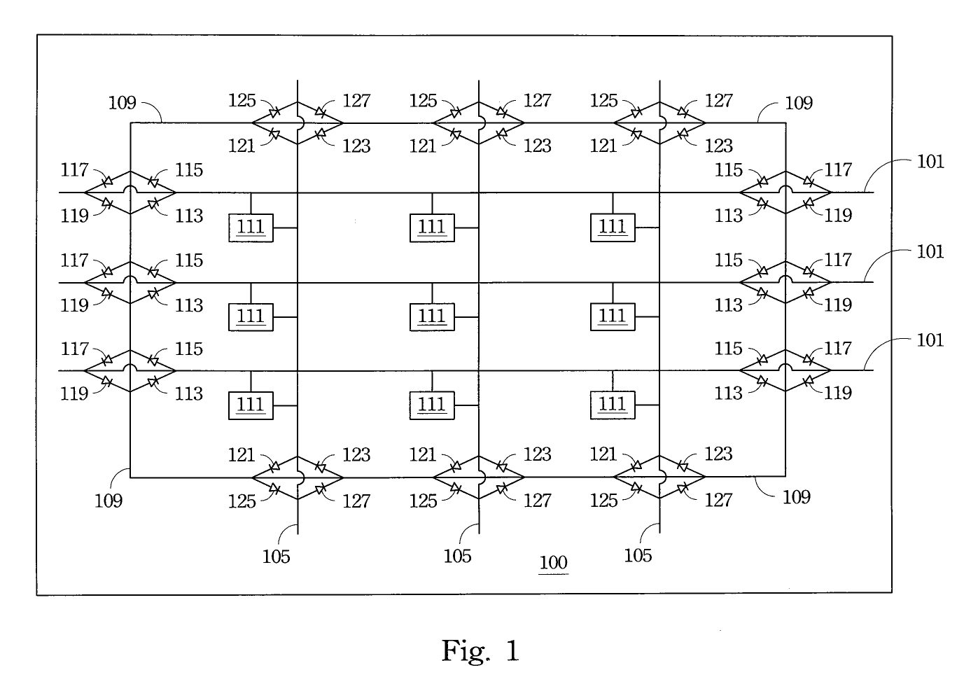

FIG. 1 is an active matrix device according to one embodiment of the present invention. The active matrix device, such as flat panel display, includes a substrate 100, scan lines 101, data lines 105, an electrostatic static discharge ring 109, pixels 111, a first diode 113, a second diode 115, a third diode 117, a fourth diode 119, a fifth diode 121, a sixth diode 123, a seventh diode 125 and an eighth diode 127. The scan line 101, data line 105, pixels 111 and the electrostatic discharge ring 109 are disposed on the substrate 100. The pixels are coupled to the scan lines 101 and the data line 105.

The scan line 101 and the data line 105 are coupled to the electrostatic discharge ring 109 through the first diode 113, the second diode 115, the third diode 117, the fourth diode 119, the fifth diode 121, the sixth diode 123, the seventh diode 125, and the eighth diode 127.

The anodes and cathodes of the first diode 113 and the fourth diode 119 are coupled to the scan lines 101 and the electrostatic discharge ring 109 respectively. The anodes and cathodes of the second diode 115 and the third diode 117 are coupled to the electrostatic discharge ring 109 and the scan line 101 respectively. The anodes and cathodes of the fifth diode 121 and the eighth diode 127 are coupled to the data line 105 and the electrostatic discharge ring 109. The anodes and cathodes of the sixth diode 123 and the seventh diode 125 are coupled to the electrostatic discharge ring 109 and the data line 105 respectively.

If the active matrix device is a thin film transistor liquid crystal display, each of the pixels 111 includes at least one thin film transistor (not shown), with a gate coupled to the scan line and a first source/drain coupled to the data line, to store the voltage appearing on the data line into the pixels.

If there is electrostatic current on the data lines or the scan lines, the electrostatic current is delivered to the electrostatic discharge ring 109 through the first diode 113, the second diode 115, the third diode 117, the fourth diode 119, the fifth diode 121, the sixth diode 123, the seventh diode 125 and the eighth diode 127, and is consumed by the electrostatic discharge ring 109. The number of these diodes can be increased as required, which can deliver and consume the electrostatic energy more selectively. In addition, if some of the diodes coupled to the data lines or the scan lines are destroyed, the electrostatic current can still be delivered and consumed by the remaining diodes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A active matrix device, comprising:
a substrate;
a scan line, disposed on the substrate;
a data line, disposed on the substrate, across the scan line;
a pixel, electrically coupled to the data line and the scan line;
at least one electrostatic discharge ring, disposed on the substrate across the data line and the scan line, wherein the electrostatic discharge ring consumes electrostatic energy;
a first diode and a fourth diode, having anodes coupled to the scan line and cathodes coupled to the electrostatic discharge ring; and
a second diode and a third diode, having anodes coupled to the electrostatic discharge ring, and cathodes coupled to the scan line.

2. The active matrix device of claim 1, further comprising:
a fifth diode and an eighth diode, having anodes coupled to the data line and cathodes coupled to the electrostatic discharge ring; and
a sixth diode and a seventh diode, having anodes coupled to the electrostatic discharge ring and cathodes coupled to the data line.

3. The active matrix device of claim 1, wherein the substrate is made of class.

4. The active matrix device of claim 1, wherein the substrate is made of plastic.

5. A flat panel display, comprising:
a substrate;
a scan line, disposed on the substrate;
a data line, disposed on the substrate, across the scan line;
at least one thin film transistor, disposed on the substrate, having a gate coupled to the scan line and a first source/drain coupled to the data line;
at least one electrostatic discharge ring, disposed on the substrate across the data line and the scan line, consuming electrostatic energy;
a first diode and a fourth diode, having anodes coupled to the scan line and cathodes coupled to the electrostatic discharge ring; and
a second diode and a third diode, having anodes coupled to the electrostatic discharge ring and cathodes coupled to the scan line.

6. The flat panel display of claim 5, further comprising:
a fifth diode and an eighth diode, having anodes coupled to the data line and cathodes coupled to the electrostatic discharge ring; and
a sixth diode and a seventh diode, having anodes coupled to the electrostatic discharge ring and cathodes coupled to the data line.

7. The active matrix device of claim 5, wherein the substrate is made of class.

8. The active matrix device of claim 5, wherein the substrate is made of plastic.
